(19) United States
(12) Patent Application Publication
(10) Pub. No.: US 2014/0338198 A1
(43) Pub. Date: Nov. 20, 2014

(54) KNIFE OPENING MECHANISM

(71) Applicants: Spencer Frazer, Lynnwood, WA (US); Beren McKay, Lynnwood, WA (US)

(72) Inventors: Spencer Frazer, Lynnwood, WA (US); Beren McKay, Lynnwood, WA (US)

(21) Appl. No.: 14/214,744

(22) Filed: Mar. 15, 2014

Related U.S. Application Data
(60) Provisional application No. 61/801,337, filed on Mar. 15, 2013.

(51) Int. Cl. B26B 1/04

(52) U.S. Cl. CPC B26B 1/04
USPC 30/161

(57) ABSTRACT

A knife opening mechanism is disclosed. In some embodiments, a knife includes a handle having a pivot pin to pivotably attach a blade to the handle, the handle having a cavity to receive the blade in a closed position, a blade pivotably connected to the handle by the pivot pin, the blade having a front tang portion and a rear blade portion, wherein the rear tang portion receives an engagement surface from a lockback bar to lock the blade in an open position and wherein the front tang portion is contoured to engage the lockback bar engagement surface to resist rotation of the blade, and a locking foot safety to lock the lockback bar when the knife is in a closed position, wherein the locking foot safety engages the foot of the lockback bar on the end of the lockback bar near the pivot pin.

### RELATED APPLICATIONS

This application claims the benefit of U.S. Provisional Application No. 61/801,337, filed Mar. 15, 2013.

### BACKGROUND

Knife opening and locking mechanisms currently utilize springs, lock back bars and cammed or radiused surfaces on a tang of a knife to assist in opening a knife, to hold a knife closed, to lock a knife closed or open, etc. In some instances, a lock back bar may be restrained to keep a knife in a closed or open position, however, a lock back bar can operate itself as a leaf spring and may flex enough to become unlocked in either orientation.

Additionally, current spring approaches are subject to a relatively consistent force curve and are not tailored to specific orientations of a knife blade. The relatively consistent force curve over the extension of a spring is currently coupled with a cammed or radiused surface to leverage more or less force upon a blade in a specific orientation. However, cam systems often require pivots, more machining, etc. and increase the cost to provide a desired functionality specifically tailored to knife blade orientation.

### SUMMARY

Accordingly, a knife opening mechanism is described below in the Detailed Description. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a side plan view of a knife having an embodiment opening mechanism.

FIG. 2 is a side section view of a knife having an embodiment opening mechanism with the knife blade in a closed orientation and a lockback bar lock engaged.

FIG. 3 is a side section view of a knife having an embodiment opening mechanism with the knife blade in a closed orientation and a lockback bar lock released.

FIG. 4 is a side section view of a knife having an embodiment opening mechanism with the knife blade in a partially open orientation.

FIG. 5 is a side section view of a knife having an embodiment opening mechanism with the knife blade in an open orientation.

### DETAILED DESCRIPTION

A disclosed knife opening mechanism may include multiple components such as a locking foot safety, a compound leaf spring, and a moment-neutral cantilever spring and tang angled surface alignment. The disclosed locking foot safety locks a lockback bar into position against a tang of the knife. Conventional approaches to locking a lockback bar involved a safety lock on the end of the lock back bar distal from the blade pivot. While this conventional approach somewhat locks the lockback bar, the lockback bar itself could effectively operate as a cantilevered spring and become unlocked by a moment on the blade even when the safety on the distal end of the lockback bar is in place. In this way a lockback bar can still automatically lock a blade in an open or closed position and a separate lock locking the foot of the lockback bar can secure the lock in the locked position.

The disclosed compound leaf spring uses constructively or destructively interfering leaf springs to create a force load that can be applied to a member which will dramatically vary based on the related spring force of the other springs in the system and the location of the member. For example, by having multiple leaf springs compress together in the shut position a knife may have a smaller opening force than a closing force. This can be used to produce a compound spring force on a locking device, such that when a tool is opened the multiple leaf springs are no longer in contact with each other and only the force of one leaf spring is needed to be overcome to open the tool. A compound leaf spring approach can use any plurality of leaf springs sufficient to fit in the space of a folding tool or knife.

In some embodiments, during the course of operation multiple leaf springs are allowed to interfere with each other. This interference can compound spring force in each spring and therefore increase the force exerted by each spring. One advantage of this approach is that it allows a designer to create a variable spring system whose position is flexible and the amount of force only relies upon spring geometry, blade geometry, etc.

A compound leaf spring in the disclosed manner operates in a similar fashion to a cam system. In a cam system the geometry of the cam surface dictates the increase in force between components. All points of the cam system however are fixed and therefore they may not hold shocks or sudden loads well. An additional advantage of a compound leaf spring approach over a regular cam system is that a compound leaf spring removes the need for a physical cam and any parts and pivots that would accompany a cam. A compound leaf spring approach therefore uses the springs that are already in the system and positions them such that they operate on a blade similar to a cam system. In this way a compound the spring can be designed to provide more or less force over a portion of rotation of the blade and a folding knife.

A disclosed moment-neutral cantilever spring and tang angled surface system uses geometry to change a force vector such that a cantilevered beam leaf spring acting on only one side of a pivot, can be used to assist the opening of the tool about the pivot and yet not hinder the tool from staying in the closed position. For example, a blade can have an angled surface on the tang of the blade. The angle can be such that the normal vector of the angle points to the pivot of the blade. In this way, the tip of a spring can be shaped such that the force of the spring is able to be resolved normal to the tangent of the point of contact of the tip. When a tool is closed, the tangent line of the spring tip is parallel to the angle of the tang, thereby directing a force vector of the spring directly at pivot of the tool and producing no moment on the tool. When the tool is rotated such that the tangent of the spring tip and angle of the tang are no longer parallel, then the spring force is resolved as a moment acting on the tool and thereby assist in the opening of the tool.

A moment-neutral cantilever spring and tang angled surface system may be constructed using a multi-leaf spring or a single tapered leaf spring. Additionally a spring tip could be chiseled, curved, a circular, or other geometry and still direct a force vector of the spring directly at the pivot of a tool or blade. In some embodiments, a moment neutral cantilever spring and tang angled surface system could be used as a standalone device for opening and shutting a blade or tool, or may be used in conjunction with the retaining device such as a ball detent, a lock back, etc.

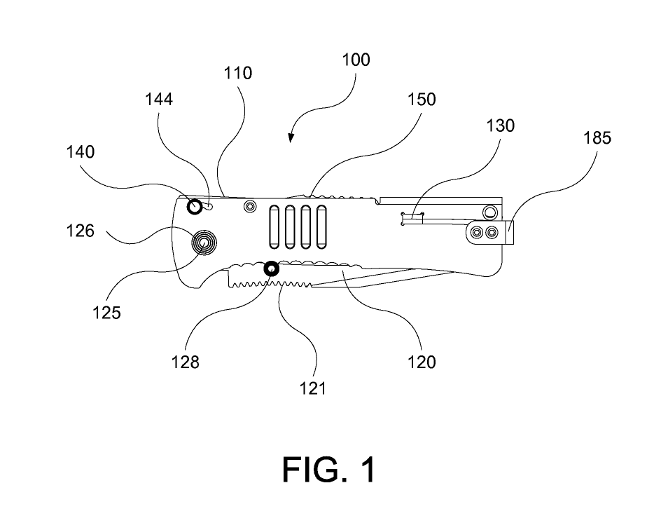

FIG. 1 is a side plan view of an embodiment knife 100 having various aspects of an opening and locking mechanisms as disclosed herein. Knife 100 includes a lockback bar 150, a blade 120 with a serrated edge 121 and a thumbstud 128. Knife 100 also has a pivot 125 connecting the blade to the knife body 110, and a channel 144 to receive a lock 140 that locks a foot of the lockback bar 150. Knife 100 also includes a reversible bayonet clip 185. Reversible bayonet clip 185 may be attached to knife 110 in multiple configurations including the clip extending the exposed face of knife body 110 in FIG. 1 or the unseen opposite face of knife body in FIG. 1.

In some embodiments, knife 100 includes a handle having a pivot pin 125 to pivotably attach a blade 120 to the handle, and the handle has a cavity to receive the blade in a closed position, a blade 120 pivotably connected to the handle by the pivot pin, the blade 120 having a front tang portion and a rear blade portion, wherein the rear tang portion receives an engagement surface from a lockback bar to lock the blade in an open position and wherein the front tang portion is contoured to engage the lockback bar engagement surface to resist rotation of the blade, and a locking axle 142, or locking foot safety, to lock the lockback bar when the knife is in a closed position, wherein the locking foot safety engages the foot of the lockback bar on the end of the lockback bar near the pivot pin.

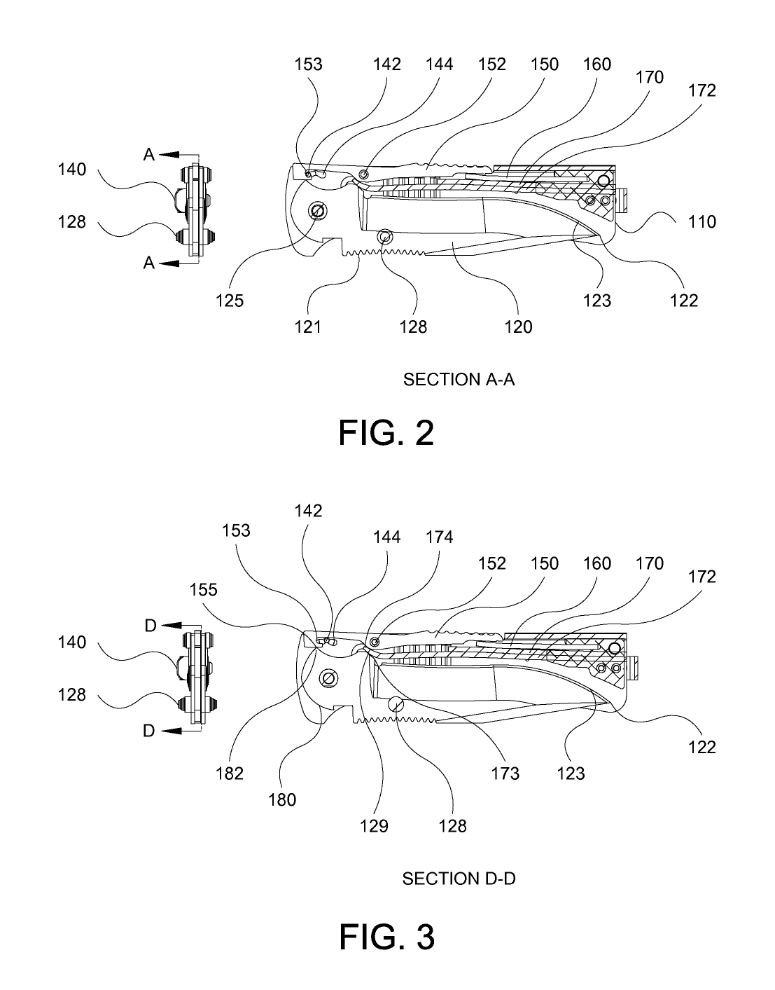

FIG. 2 is a side section view of a knife having disclosed opening mechanisms with the knife blade in a closed orientation and a lockback bar lock engaged. With reference to FIG. 2, the knife has a handle 110 and the blade coupled to the handle with blade. 125. Knife blade 120 includes a blade edge 123, a blade tip 122, a thumb stud 128 and a serrated portion 121. Knife handle also includes its first leaf spring 172, a second leaf spring 170, and a floating spring 160, wherein the floating spring is configured to apply force to a lockback bar 150. In the disclosed embodiment, lockback bar 150 is a rocker about lockback bar pivot 152 having a locking foot that interfaces with the blade tang. Also shown in FIG. 2 is a lock axle 142 deck and slide along channel 144 and into recess 153 and locking foot of the lockback bar 150.

As can be seen with reference to FIG. 3, when the lock axle 142 is moved towards the base of the knife handle through channel 144 the actual disengage from the recess 153 and therefore lockback bar is free to move by depressing the floating spring 160. When lock axle 142 is disengaged from recess 153, the locking foot 155 of lockback bar 150 is in contact with the protrusion 182 on the tang of knife blade 120. In this orientation, the blade may be opened by pushing on the thumb stead or polling on the blade and overcoming the spring force of the lockback bar in floating spring combination placed upon the tang that protrusion 182. Additionally, in this configuration the compound leaf spring combination of a first leaf spring 172 in the second leaf spring 170 shown with the tip 174 of the first leaf spring 172 placed against a surface of the tang such that substantially no moment about pivot 125 is imparted on the blade.

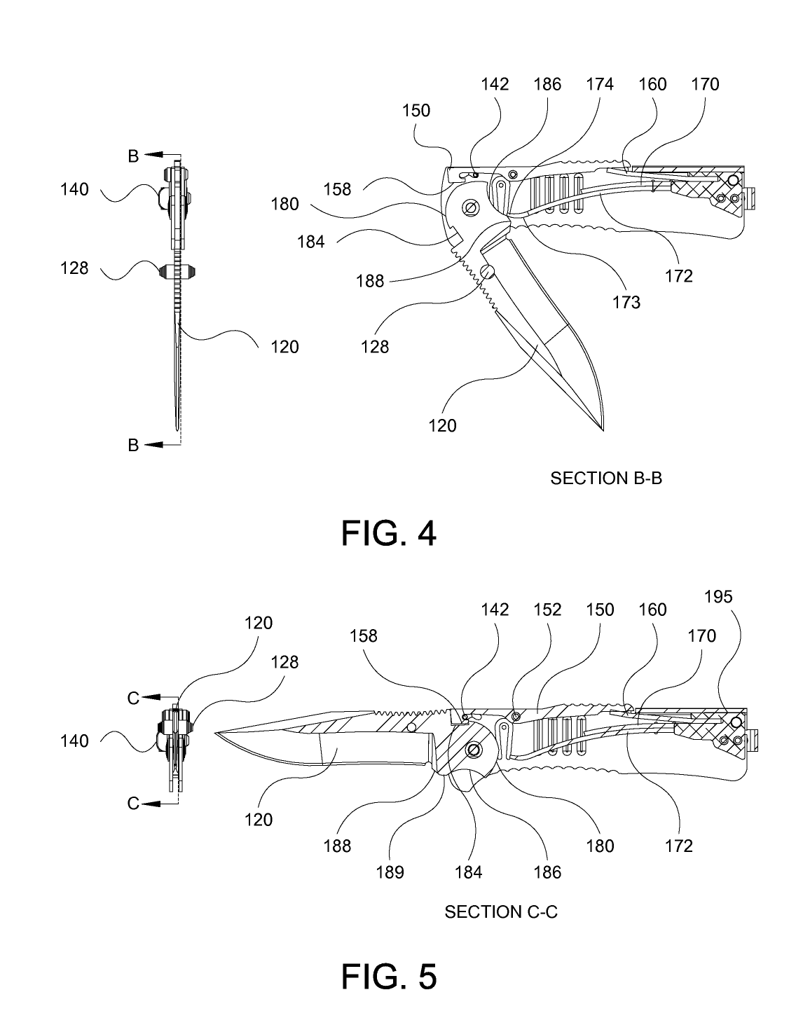

With reference to FIG. 4, blade 120 is in a partially extended position in spring tip 174 of first leaf spring 172 is shown providing a force on blade 120 causing the blade open. In some embodiments, the rounded in surface 180 of the tang of blade 120 can have a decreasing radius or cam surface such that the lockback bar when operating in combination with the spring force of floating spring 160 can provide an assisted opening by the decreasing radius in surface 180. However, some embodiments may have a consistent radius or other radius than a decreasing radius.

Turning now to FIG. 5, the blade 120 is shown in open orientation with locking foot 158 situated in the recess 184. Additionally, locking axle 142 is shown in the lock foot recess 153, therefore locking the locking foot of the lockback bar 150 into recess 184.

It will further be understood that the configurations and/or approaches described herein are exemplary in nature, and that these specific embodiments or examples are not to be considered in a limiting sense, because numerous variations are possible. The subject matter of the present disclosure includes all novel and nonobvious combinations and subcombinations of the various processes, systems and configurations, and other features, functions, acts, and/or properties disclosed herein, as well as any and all equivalents thereof.

1. A knife, comprising:
a handle having a pivot pin to pivotably attach a blade to the handle, the handle having a cavity to receive the blade in a closed position;
a blade pivotably connected to the handle by the pivot pin, the blade having a front tang portion and a rear blade portion, wherein the rear tang portion receives an engagement surface from a lockback bar to lock the blade in an open position and wherein the front tang portion is contoured to engage the lockback bar engagement surface to resist rotation of the blade; and
a locking foot safety to lock the lockback bar when the knife is in a closed position, wherein the locking foot safety engages the foot of the lockback bar on the end of the lockback bar near the pivot pin.
